(19) United States
(12) Patent Application Publication
(10) Pub. No.: US 2011/0267804 A1
(43) Pub. Date: Nov. 3, 2011

(54) ELECTRIC FIRE

(75) Inventors: Martin Betz, Annagassan Co. Louth (IE); Arthur Purton, Dublin (IE)

(73) Assignee: BASIC HOLDINGS, Cloghran, Dublin (IE)

(21) Appl. No.: 13/140,188

(22) PCT Filed: Dec. 14, 2009
(86) PCT No.: PCT/EP2009/067125

§ 371 Date: Jul. 20, 2011

(30) Foreign Application Priority Data
Dec. 17, 2008 (GB) 0822965.0

(51) Int. Cl. F21V 33/00

(52) U.S. Cl. 362/101

(57) ABSTRACT

An electric fire is described. By incorporating a liquid within a container within the fire, it is possible to effect flicker effects on a screen. A flame pattern is defined by selectively illuminating portions of the screen greater than other portions.

### FIELD OF THE INVENTION

The present invention relates to electric fires and in particular to electric fires which include a flame effect simulator which operably provides for the generation of flame effects within the fire.

### BACKGROUND

Electric fires are well known in the art. Such fires typically include a heating element in for example the form of a fan heater or the like and operably provide for the generation of heat. Such fires have traditionally been provided to replace real combustion fires.

As part of this replacement of the real fire it is known to provide electric fires with flame effect simulators which are usefully employed to generate flame effects within an interior of the electric fire such that a user gets the visual impression of a fire burning within the fire. Such flame effect simulators are typically combined with an artificial fuel bed which provides for a simulation of the combustible material that is employed within the electric fire.

With the development of central heating within a domestic environment it is known that the electric fire provides a focal point within the room where it is located and the necessity for the heating element of the fire is not as prevalent. It is therefore known that electric fires can be provided without heating elements and within the context of the present invention the term electric fire is used to describe those fires that both include and omit heating elements.

There are many ways to provide flame effects within a fire. One departure from traditional methodologies to simulate flame effects is described in EP1703211 which provides for the utilisation of a fluid filled container between a light source and a screen. Rotation of the container effects a corresponding movement of the fluid and this is used to affect the transmission of light from the light source through the container and onto the screen. Use of a refractor screen between the fluid filled container and the screen is described. The refractor screen provides for a break-up of the transmitted light prior to incidence on the screen. The arrangement described is useful in generating a flicker effect which is visible on the screen but there are still problems in that the effect is not really a flame effect as there is no real identifiable flame pattern visible or defined on the screen.

There is therefore a need for an improved electric fire which can simulate flame effects on a screen within the fire.

### SUMMARY

These and other problems are addressed by an electric fire provided in accordance with the teaching of the present invention. Such a fire includes a housing providing support for a flame generating screen on which a flame pattern may be generated. The fire includes a flame generating means comprising a liquid and being located between the screen and a light source such that light emitted from the light source is incident onto the liquid prior to incidence onto the screen. Typically the arrangement is such that the light will pass through the container prior to incidence onto the screen but other modifications could provide for a reflection of the light off the liquid within the container prior to incidence onto the screen. The fire further comprises means for defining the flame pattern generated on the screen, such that selective portions of the screen will be illuminated greater than other portions. This means for generating the flame pattern is co-operable with the transmitted light from the light source so as to specifically direct light onto specific portions of the screen.

The liquid is desirably provided within a container which may be located behind or in front of the screen. If it is located to the rear of the screen the transmitted light will initially be on a rear surface of the screen. If it is located to the front of the screen, the transmitted light will initially fall on the front of the screen.

The means for defining the flame pattern may comprise at least one lens provided between flame generating means and the screen, the at least one lens providing for a focusing of the light passing from the flame generating means so as to selectively direct the light onto the screen. By using a lens arrangement it is possible to selectively direct the light to generate individual flames of a flame pattern. In a preferred arrangement a plurality of lens are provided, each of the lenses being associated with an individual generated flame within the flame pattern.

The means for defining the flame pattern may comprise in addition or alternatively to the lenses a mask provided between the container and the screen, the mask having a fire pattern template provided therein, such that light passing through the mask and onto the screen will adopt the pattern of the template

The flame generating means may include a moveable container. The movement of the fluid within the container will effect a disruption of the light passing through the container. The container could also be stationary and the movement of the fluid could be effected through use of an agitator in the form of for example a paddle which imparts movement to the fluid.

The fire may also include a fuel bed located to the front of the fire and forwardly of the screen. The screen may comprise an at least partially reflective screen, such that it is possible to mirror the fuel bed so as to give the impression that the flame pattern displayed on the flame generating screen originates from a mid portion of the fuel bed.

Accordingly the invention provides an electric fire according to claim 1. Advantageous embodiments are provided in the dependent claims.

These and other features of the present invention will be better understood with reference to the following drawings.

### BRIEF DESCRIPTION OF THE DRAWINGS

The present invention will now be described with reference to the accompanying drawings in which:

FIG. 1 is a section through a fire provided in accordance with the teaching of the present invention.

FIG. 2 is a front view of the fire of FIG. 1.

FIG. 3 is a section through a fire provided in accordance with the teaching of the present invention.

### DETAILED DESCRIPTION OF THE DRAWINGS

Exemplary arrangements of a fire provided in accordance with the teaching of the present invention will be described hereinafter to assist with an understanding of the benefits of the present invention. Such a fire will be understood as being exemplary of the type of fire that could be provided and is not intended to limit the present invention to any one specific arrangement as modifications could be made to that described herein without departing from the scope of the invention.

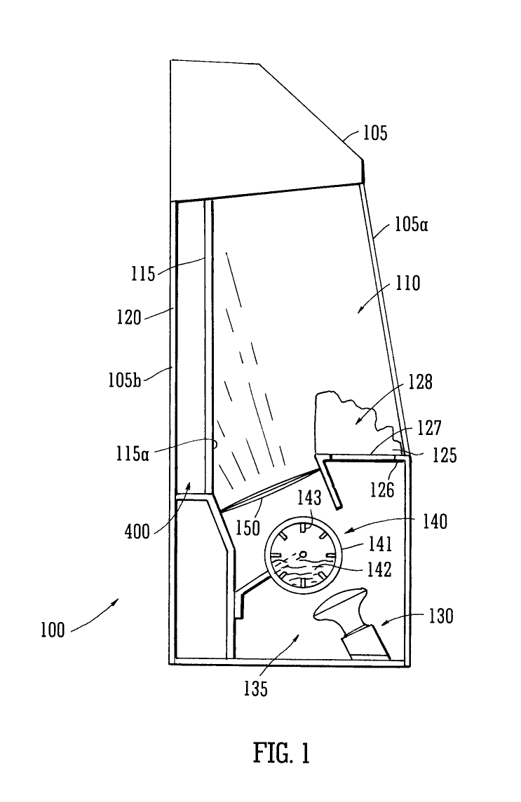

As shown in FIG. 1 a fire 100 includes a housing 105 which defines an interior volume 110. The housing has a front portion 105a and a rear portion 105b. Within the interior volume is supported a screen 115 onto which a flame pattern may be operably provided. On generation of a flame pattern a user of the fire located to the front of the fire will see the flame pattern on the screen. The screen 115 is, in this arrangement, typically located towards the rear 105b of the fire and may be parallel with, or as shown in FIG. 1, offset forwardly of a rear wall 120 of the housing 105. In this arrangement a gap 400 is provided between the rear wall 120 and the screen 115

Located towards the front 105a of the fire at a level substantially coincident with the bottom of the screen 115 is provided a fuel bed 125. As shown in

FIG. 1 the fuel bed 125 may be located on a supporting shelf 126 which may include an at least partially transparent surface 127. It will be appreciated that any supporting arrangement may be usefully employed. By providing an at least partially transparent surface 127 or indeed by providing a gap underneath the fuel bed 125, light below the fuel bed may be transmitted up into the fuel bed. If the fuel bed includes portions that are at least partially transparent or translucent then it will appear as if the fuel bed is internally illuminated.

A light source 130 is provided in a lower or bottom region 135 of the housing and may be used to illuminate the screen 115 and optionally the fuel bed 126. If used to illuminate the fuel bed, it will be appreciated that the use of the at least partially transparent surface 127 will operably allow light generated by the light source to pass upwardly into the fuel bed and to illuminate an interior volume 128 thereof. By providing the fuel bed in a suitable material which is at least partially transparent such interior illumination will be visible by a user located to the front of the fire. If the fuel bed is only supported at its perimeter it will be understood that the use of the partially transparent surface 127 may not be necessary in that there is no occluding surface between the light source and the fuel bed.

Flame generating means 140 comprising a container 141 having a fluid 142 provided therein are provided between the light source 130 and the screen 115. In the arrangement shown, the flame generating means are located forwardly of the screen 115. In this way light generated by the light source 130 will pass through the flame generating means 140 and be incident on a front surface 115a of the flame generating screen where it may be used to create the visual impression of one or more flames. Movement of the liquid is operably to create a suitable flame pattern. It will be appreciated that as light is being transmitted through the container that any movement of the liquid within the container will affect the transmission of the light and can, as a result, be used to generate a flicker effect on the screen.

Desirably the fluid 142 only partially fills the container 141, typically at most half filling. The container 141 may be moveable so as to impart motion to the fluid within the container. One or more projections 143 may be provided on an inner surface 144 of the container so as to effect more disruption to the fluid as it is moved. Furthermore, one or more moveable solid elements could be provided within the container. These elements will move within the liquid but the effect of the liquid will serve to dampen that movement.

It will be understood that as the container 141 is located between the screen 115 and the light source that the light from the light source 130 that is incident on the screen 141 will have been affected by the operation of the flame generating means 140. The movement of the container may be effected in a number of different ways, typically by use of a motor that is used to drive an actuator coupled to the container 141.

The screen 115 may be provided with an at least partially reflective surface such that a reflected image of the fuel bed 125 that is located to the front of the fire will be viewable off this at least partially reflective surface. Due to the reflection of the fuel bed, the generated flame pattern will appear to a person located to the front of the fire to originate from a mid portion of the fuel bed, thereby enhancing the optical effect of the flame effect generated. In another arrangement a second screen is provided to the front of the screen on which the flame pattern is generated. This second screen will be at least partially transparent such that light from the container will pass through the second screen and onto the first screen where it will generate a flame pattern. The second screen if used will typically be provided with an at least partially reflective surface to create the fuel bed mirroring effect discussed immediately above.

So as to enhance the definition of the flame pattern viewable on the screen 115, the present invention provides means for defining the flame pattern generated on the screen. Such means provide for control of the light path from the flame generating means onto the screen such that selective portions of the screen will be illuminated greater than other portions. FIG. 1 shows a first embodiment of such means, the incorporation of at least one lens 150 provided between the flame generating means and the screen. The lens provides for a focusing of the light that has passed through the flame generating means 140 onto specific portions of the screen 115. The lens provides an exemplary flame focusing means and it will be appreciated that other optical arrangements that provide for a focusing of light onto the screen could also be used. If the flame focusing means is implemented using one or more lenses it is desirable that the lenses are of the type known as convex lenses. Their focal length is such that the parallel light that passes through the flame generating means is then focused onto specific regions of the flame generating screen 115. It will be understood that level of focusing achieved will depend on the distances between the lenses and the screen and the optical properties, for example the focal length, of the lens. While shown schematically as a single convex lens, other optical arrangements could be used, and such modifications will be apparent to the person skilled in the art. By using a lens arrangement that provides for a selective illumination of portions of the flame generating screen it is possible to generate individual flames within the flame pattern. It is also possible, though not shown for the light to be focused prior to incidence through the flame generating means. Such focusing could be provided by having the light source 130 provided with an integral lens system or by providing a separate lens arrangement between the flame generating means and the light source

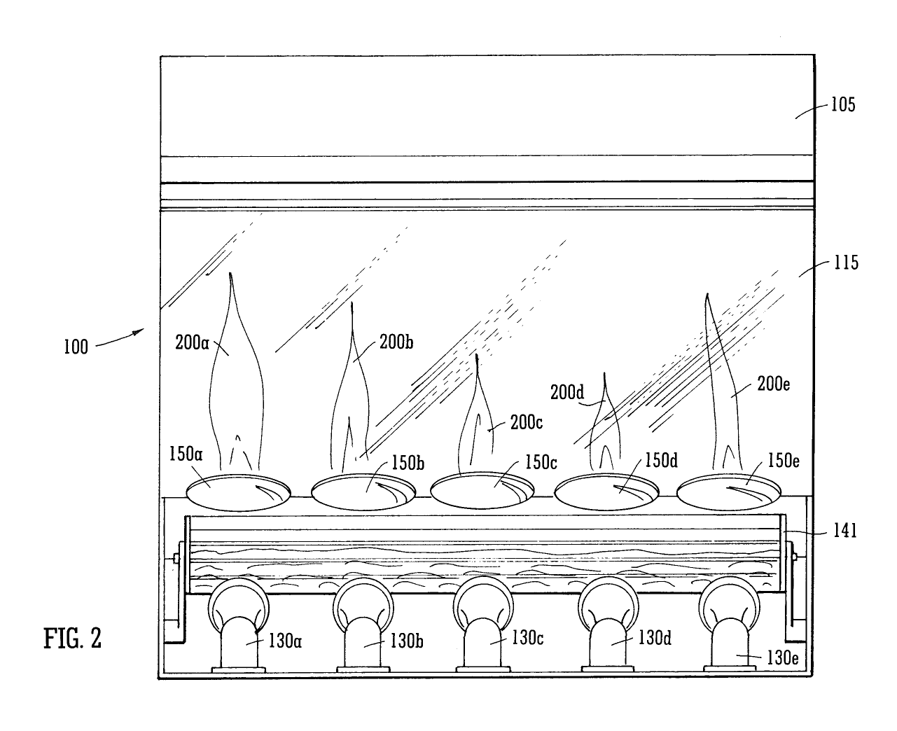

FIG. 2 shows a front view of the fire of FIG. 1. While it is possible to illuminate the flame generating means 140 with a single light source, in this arrangement a plurality of light sources 130a, 130b, 130c, 130d, 130e are provided, each being selectively directed onto different portions of the container 141 within which the liquid 142 is provided. The light that passes through the liquid and the container then passes through a selected one of a plurality of lenses 150a, 150b, 150c, 150d, 150e each of which are configured to optically direct the light onto specific portions of the flame generating screen so as to generate images of individual flames 200a, 200b, 200c, 200d, 2003. By judiciously choosing the optical properties and orientation of each of the lenses 200 it is possible to arrange for different ones of the flames to have different dimensions—be that width and/or height. It will be appreciated that each one of the individual lenses 150 are related to a specific flame 200 and in this exemplary arrangement there is a 1:1 relationship between the two. In such a circumstance if one wanted to create for example 5 flames, then 5 lenses would be provided. The resultant flame pattern has a defined geometry related to the optical properties of the lenses and a flicker effect resultant from the movement of the liquid within the container. It will be appreciated that the arrangements described heretofore relate to a 1:1 relationship between the flame generated, a lens and the light source. It will be appreciated that one light source could be used with several lenses or indeed that several light sources could be used with the same lens arrangement.

By providing a plurality of individual light sources the light output from each of the light sources can be individually varied such that selective portions of the screen 115 can be simultaneously illuminated with different colours. This may be advantageously provided by including one or more multicoloured light emitting diodes (LEDs) within the light source arrangement whose colour output can be varied depending on application of a suitable control signal. Alternative methodologies using for example mechanical filters could be used but the colour variability using such LED's makes them a preferred choice if colour variation is required.

As the cylinder rotates the fluid contained therein will also move and this movement will affect the light intensity of the light being transmitted through the cylinder. The nature of the movement is such as to create flicker effects in the displayed pattern. While the lenses will serve to selectively illuminate portions of the flame generating screen so as to create the impression of individual flames, the flame generating means creates the required flicker effect that one would expect from convention combustion of a fuel.

Referring back to FIG. 1, it will be appreciated that the flicker effect that is transmitted into the light passing through the cylinder may also be used to generate a flicker effect in the fuel bed. As the underside of the fuel bed is within the light path of the light passing outwardly from the cylinder it too will be illuminated differently depending on the rotation of the cylinder.

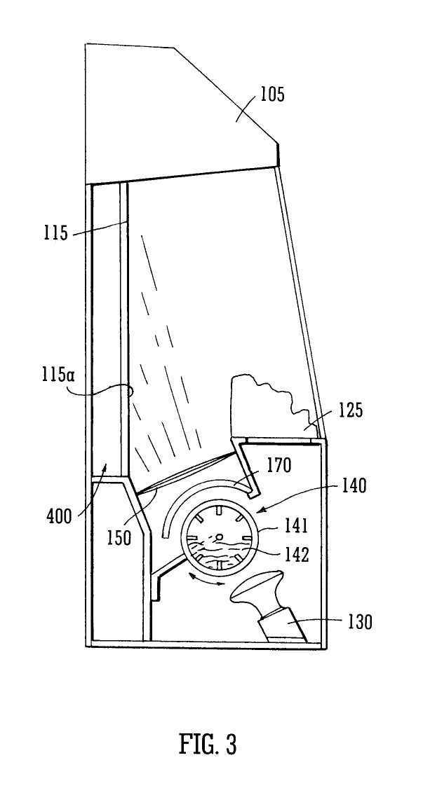

FIG. 3 shows an alternative means of defining the flame pattern on the screen 115. In this arrangement a baffle or mask 170 is provided between the container 141 and the screen 115. The mask has a fire pattern template provided therein, such that light passing through the mask and onto the screen will adopt the pattern of the template. The pattern may be effected by providing a cut out in a metal sheet or the like or by providing regions of different transparency in a continuous element, such that light passing through the regions of greater transparency will be of higher intensity on the screen. By providing such a mask it is possible to constrain where on the screen light will be incident and those define appropriate flame patterns. The light that is incident will flicker as a result of the movement of the liquid.

While FIG. 3 shows the mask 170 located between the container 141 and the lens 150, it will be appreciated that the lens could also be provided between the container and the mask. Furthermore, certain arrangements could be implemented without any lens or other optical element at all.

It will be appreciated that what has been described herein is an exemplary arrangement of an electric fire that includes a flame generator located forwardly of a flame generating screen so as to provide for light modified by the flame generator to be incident on a front surface of a flame generating screen. While not shown, it is possible for the flame generating components, ie the light source, container and fluid to be provided to the rear of the screen as well. In such arrangements the means for defining the flame pattern would also have to be provided to the rear of the screen. The light that passes from the light source through the liquid and defined by the pattern of the mask or the use of lenses would be incident on a rear surface of the screen as opposed to a front surface—such as that heretofore described. It will be appreciated that in such a configuration the screen 115 would have to be at least partially transparent to allow for light incident on the rear surface to be visible from the front of the fire.

In the arrangements described, a lens arrangement may optionally be provided to provide for the generation of individual flames within a flame pattern. The orientation and optical parameters of individual ones of the lens arrangement may be used to selectively change the shape and height of the displayed flames. Two or more lenses could be arranged in a compound lens arrangement which can be usefully employed to generate specific flame effects on the screen. While the embodiment illustrated show the lenses provided between the container and the screen, it will also be understood that modifications to that described could provide the lenses between the light source and the container such that the lenses (or equivalent optical elements) could be used to specifically target light onto specific regions of the container.

By using multicoloured light sources it is possible to also change the colour sequences of the displayed flame pattern over time.

While the invention has been described with reference to preferred arrangements and embodiments it will be appreciated that modifications can be made without departing from the teaching of the present invention.

The words comprises/comprising when used in this specification are to specify the presence of stated features, integers, steps or components but does not preclude the presence or addition of one or more other features, integers, steps, components or groups thereof.

1. An electric fire comprising:
a. A light source;
b. A container for holding a liquid;
c. Means for effecting movement of the liquid within the container;
d. A screen on which a flame pattern is generated,
e. Means for defining the flame pattern generated on the screen, such that selective portions of the screen will be illuminated greater than other portions and
wherein the light source, container and screen are arranged relative to one another such that operably light emitted from the light source is incident on the liquid prior to passing onto a front surface of the screen, the movement of the liquid effecting generation of flicker effects within a generated flame pattern on the screen.

2. The fire of claim 1 comprising at a fuel bed located to the front of the screen.

3. The fire of claim 2 wherein the screen comprises an at least partially reflective surface such that an image of fuel bed is mirrored off the screen and the generated flame pattern appears to originate from a mid portion of the fuel bed.

4. The fire of claim 1 wherein the means for defining the flame pattern comprises at least one lens located between the light source and the screen such that light from the light source is focused so as to selectively direct the light onto the screen.

5. The fire of claim 4 wherein the at least one lens provides for generation of individual flames within the generated flame pattern.

6. The fire of claim 4 wherein the at least one lens is provided between the container and the screen.

7. The fire of claim 4 wherein the at least one lens is provided between the light source and the container.

8. The fire of claim 4 wherein a plurality of lenses are provided, individual ones of the plurality of lenses being associated with individual generated flames within the flame pattern.

9. The fire of claim 8 wherein the light source includes a plurality of lighting elements whose output colour can be varied to as to enable a selective colouring of individual ones of the individual generated flames.

10. The fire of claim 4 wherein the orientation and/or optical properties of the at least one lens is selectable to change the dimensions of the generated flames.

11. The fire of claim 1 wherein the means for defining the flame pattern generated on the screen comprises a mask provided between the container and the screen, the mask having a fire pattern template provided therein, such that light passing through the mask and onto the screen will adopt the pattern of the template.

12. The fire of claim 1 wherein the container is moveable, movement of the container effecting a corresponding movement of the fluid therein.

13. The fire of claim 1 further comprising an agitator for effecting agitation of the liquid within the container to impart movement to the liquid.

14. The fire of claim 1 wherein the screen is located to the rear of the fire housing, the container and means for defining the flame pattern generated on the screen being located forwardly of the screen.

15. The fire of claim 1 comprising one or more solid elements provided within the liquid.

16. The fire of claim 1 wherein the screen on which a flame pattern is generated is a first screen of the fire, the fire including a second screen provided between the first screen and the container, the second screen being at least partially transparent such that light can pass through the second screen and onto the second screen.

17. The fire of claim 16 wherein the second screen is also at least partially reflective.

18. The fire of claim 1 wherein the light source comprises a plurality of lighting elements, individual ones of the elements providing a light output that is directed onto specific regions of the container.

19. The fire of claim 4 comprising a plurality of lenses arranged in a compound lens arrangement.

20. (canceled)
